(19) United States
(12) Patent Application Publication
(10) Pub. No.: US 2013/0067035 A1
(43) Pub. Date: Mar. 14, 2013

(54) SYSTEM AND METHOD FOR CLOUD BASED DELIVERY AND DISPLAY OF CONTENT ON MOBILE DEVICES

(71) Applicants: Omar AMANAT, Pine Brook, NJ (US); Anthony SASSO, Parkland, FL (US)

(72) Inventors: Omar AMANAT, Pine Brook, NJ (US); Anthony SASSO, Parkland, FL (US)

(73) Assignee: BUBBLE ADS HOLDINGS LLC, New York, NY (US)

(21) Appl. No.: 13/228,184

(22) Filed: Sep. 8, 2011

(51) Int. Cl. G06F 15/16

(52) U.S. Cl. 709/219; 709/217

(57) ABSTRACT

An end to end system and method for cloud based delivery of content and floating display of the content on a mobile device is presented. The system and method presented are suitable to delivery of any type of mobile content but are particularly adapted for delivery and distribution of mobile advertising, coupons and other promotional material. The mobile device is arranged to receive content from a content server via the cloud and display the content in a real time, non-intrusive floating bubble over the mobile devices currently active screen layer on the devices graphical display. The floating bubbles are simulated through the acquisition of a screen shot of a currently active mobile app, overlaying a bubble over the screen shot, and then presenting the composite image in a series of frames to simulate motion of the bubble ad over the previously top layer screen. As the bubble is presented on the screen, the mobile device reacts to the user's touch such that if the user touches a floating bubble a variety of choices may be presented, including full screen display of the bubble advertisement or content, sharing the content with friends through social networking or email, or calling or contacting the advertiser. If the user touches elsewhere the mobile device reverts to the previously active app. The system is further arranged to provide that the delivered content be targeted to users through a variety of features including user selection of content they wish to receive, user location, time of day, weather, past interest history and/or a combination of those criteria.

### FIELD OF THE INVENTION

The present invention is directed generally to a system and method for cloud based content delivery. More particularly, the invention includes a computer system and method for cloud based targeted delivery of promotional material, advertisements, coupons and the like to mobile devices via the cloud, and display of that content in a non-intrusive overlay floating above the top level screen layer.

### BACKGROUND OF THE INVENTION

Consumer product companies and marketers among others are always seeking new and innovative means to effectively reach consumers while doing so in the least intrusive and most effective manner possible.

Traditionally advertisements and coupons have been delivered to consumers through mass media outlets via newspapers, magazines and television. While those means of promotion are still in extensive use, the pervasive reach of the internet and use of mobile devices has given advertisers the opportunity to use electronic media delivery of advertisements and coupons in a more directed and cost effective manner. For example, advertisers can deliver promotional material and coupons direct to consumers quickly, easily and on a large scale through email, text message, or contextual, floating, pop-up, or banner ads in web browsers, or via direct placement in apps such as games, text messaging apps and dedicated adware or coupon applications. Online advertising has become a huge industry. Advertiser spending on on-line advertising is predicted to reach US $34 billion in 2012.

These known methods of ad delivery however suffer from a number of shortcomings. First, most of these known delivery methods require that a user be actively using the application presenting the coupons. For example, contextual ads are displayed in a web browser when a user runs a search in a web search engine such as Google or Yahoo. Similarly floating, pop-up, and banner ads are typically displayed in a web browser, email program or the like only when the user is viewing other content. And, in other app placement such as games and dedicated adware programs, the user must open the app to access or be exposed to advertisements. These restrictions have the disadvantage that ad placements can only reach users when users are actively using ad placement applications and then only when the user is in the portion of the application or medium the advertiser is using to deliver ads. One attempt to solve this shortcoming is the use of text message, email alerts or other app alerts on mobile devices. This method however suffers from a number of draw backs. For example, the ability to send user's text messages through their telephone number is restricted by “do not call” lists and is likely to evoke a negative response from users who do not want the cost and interruption associated with text messaging. Similarly, while app alerts on mobile devices can let a user know there is some new activity in an application, such as receipt of a new email message, they do not present image content to the user, allow user interaction or otherwise allow control over the presentation or actions of the alert.

Aside from these difficulties of reaching users, the known delivery methods suffer from other problems. One is effectively reaching consumers who want to see the advertisement. Although the known electronic delivery methods are cost effective for advertisers to reach large numbers of people, the advertisements are frequently ignored or irritate users. For example, with respect to in app advertising, once a user is in an app, such as a web browser or game, the user is typically there for the purpose of accessing web content, sending an email or playing a game, and the user does not want to be distracted by or pay attention to an ad. Additionally, the user may simply be inundated with so many advertisements not directed to the consumers interests, or by ads that are too intrusive (e.g., they block the screen and aggravate users) or not intrusive enough (e.g., banner advertisements that a user can ignore and tune out), that they are ineffective.

Therefore there is a need for a mobile content delivery system that can effectively reach consumers while being both cost effective to deliver and receive, and as non-intrusive as possible. There is a further need for a system that permits advertisements and marketing material to be directed or targeted to consumers so that users are only receiving information that is relevant and of interest to them. There is yet a further need to provide a system that is of no cost to the consumer and does not interfere with a user's ordinary use of their mobile device.

### SUMMARY

The present systems and method addresses these needs by providing an end-to-end cloud based web service mobile platform for delivering targeted content to mobile devices in real time and in a non-intrusive manner. The mobile content is delivered to mobile devices through the cloud via push or polling technology, and is displayed on the mobile device in a non-intrusive simulated bubble floating over the top layer of the currently active screen, so that the user does not need to be in a special application to view the content. The system and method also includes features for targeting the delivery of content to only those users who wish to receive the content or are most likely to receive benefit or want the content. The present system and method further includes systems which permit users to share the content with other users via social networking and other means.

It is an object of the present invention to provide non-intrusive advertisement or content delivery whereby a transparent floating image is provided over the top layer of the mobile phone screen. It is a further object of the present invention to simulate the floating image by taking a snapshot of the current top level screen and then display a composite image of the advertisement and snapshot as the new top level screen thereby giving the user the appearance that the mobile device's prior top level screen is still the active screen.

It is yet another object of the present invention to present the floating image as a semi-transparent image whereby the underlying screen can be seen through the floating image, and yet another aspect to move the floating image around the screen of the mobile device so that it will further capture the user's attention while not obstructing any portion of the underlying screen for an excessive period of time.

It is still another object of the present invention to direct or target content to users based on one or more of user selection, location, time, weather, or prior viewing history.

It is still a further object of the invention to deliver advertisement and content through the “cloud” to the mobile devices IP address and alternatively, push content to user mobile devices or have user mobile devices periodically poll content servers for new content.

It is still a further object of the invention to provide users an option to accept and share content socially through social media forums such as Twitter, Facebook and directly to other users of the present invention, or alternatively to email content by touching or popping the floating content bubble.

The advantages and features described herein are just a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims. For example, while the system and method is generally presented herein with respect to, and for use with, delivering advertisements, coupons and other promotional material, it is extensible to any type of mobile content sharing or alerting on mobile devices.

### BRIEF DESCRIPTION OF THE DRAWINGS

Additional aspects, features, and advantages of the invention, both as to its structure and operation, will be understood and will become more readily apparent when the invention is considered in light of the following description made in conjunction with the accompanying drawings that illustrate certain non-limiting embodiments of the disclosure, wherein:

FIG. 1 is a diagram of the cloud based web service mobile platform architecture for coupon and content sharing.

FIG. 2 is diagram of the end-to-end system and flow diagram for delivery and display of content on mobile devices.

FIG. 3 is a diagram illustrating content delivery using exemplary push technology.

FIG. 4 is a flow chart illustrating the operation of the mobile device to receive, process and display content.

FIG. 5 is a flow chart illustrating the process for simulating display of floating content on mobile devices.

FIG. 6 is an exemplary portion of a relational database for storing user and content data.

FIGS. 7A-7B are screen shots illustrating the overlay of content on a mobile device graphical display.

FIGS. 8A-8F are screen shots illustrating configuration and menu screens associated with the content sharing application.

### DETAILED DESCRIPTION

The exemplary embodiments are discussed below with reference to a system and method for mobile delivery of promotional material, advertising and coupons, and as depicted in accompanying drawings. It will be understood, however, that the technology disclosed is equally applicable and adaptable to all types of mobile content delivery, and that a skilled artisan will readily recognize other similar examples equally within the scope of the invention.

The content delivery system described below provides for end-to-end delivery of content to mobile devices. The exemplary system for mobile content delivery provides real time content delivery in a non-intrusive manner, targeted to consumers who have requested the content, or who are likely to be interested in the content due to location, weather, past interest or other criteria. With the present system and method, consumers choose their own unique content which is then delivered via a cloud based mobile tool direct to the user's mobile device.

By delivering targeted content requested by the user, the system presented herein solves the problems associated with getting spam text message advertisements and conventional mobile pop-up ads like AdMob that have little relevance to the recipient as these known systems just churn out content irrespective of the recipients' interests. The present invention further improves upon prior solutions in that, unlike known systems, the content and coupons are displayed using a unique non-intrusive overlay simulation.

Additionally, unlike known systems, the present system and method allows a user to simply tap a floating bubble overlaying on the user's currently active top layer screen and the user will then receive content related to the targeted bubble advertisement. If the user is not interested in the advertisement, the user simply touches the graphical display screen anywhere outside the advertisement, the advertisement bubble pops and the user is returned to the previous top layer screen. The exemplary systems discussed in further detail below with reference to the attached figures eliminates paper coupons while resolving the deficiencies of known electronic distribution systems, saving time and money for both users and advertisers.

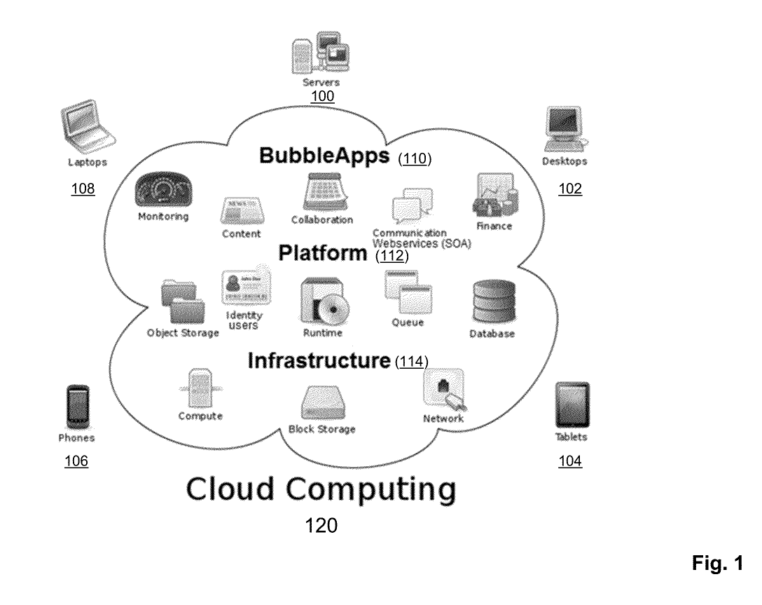

As depicted in FIG. 1, mobile devices, such as phone (106) and tablets (104), having a BubbleApps client app installed can access BubbleApps content via the cloud (120) comprising the BubbleApps back-end (110), platform (112) and infrastructure (114). The system depicted in FIG. 1 includes a BubbleApps back-end server app which runs on BubbleApps server (100) and a BubbleApps client side application installed on user mobile device (106). The back-end server side application is used for tasks such as managing and delivering content, and maintaining finances and user data. The client side application is used for communication and display of content on the mobile device.

Servers (100) are computers running server software to provide services to other computer programs (and their users) in the same or other computers. The BubbleApps web server hosts the web services and is responsible for all security built into the application. Laptops (108) can be any portable computer used to connect to the BubbleApps website which provides for registration of users and advertiser with their specific login. Phones (106) can be any type of smart phone running a mobile operating system with data communications capability including, for example, smart phones running the Android, OS, Blackberry OS or Windows Phone. Phones running these operating systems, including iPhone, HTC EVO, and Samsung Focus, provide access to mobile application stores where users can download applications for enhancing the user experience. Using a smart phone connected to an application store, users can download an application for providing an application to interface with the BubbleApps servers (100).

The BubbleApps client side application uses web services to connect to the BubbleApps server (100). The web services used by the mobile client application access the application's server side business classes via an HTTP/SOAP call. Web services/service-oriented architecture (SOA) is an evolution of distributed computing based on the request/reply design paradigm for synchronous and asynchronous applications. The BubbleApp's business logic or individual functions are modularized and presented as services for the BubbleApps client applications. SOA services have self-describing interfaces in platform-independent XML documents. Web Services Description Language (WSDL) is the standard used to describe the services.

The middleware or platform (112) is responsible for (i) receiving and sending content from the business system, (ii) receiving contents from the mobile application, (iii) processing content from the mobile application in order, and (iv) storing messages from the business system for a device, until that device connects. This information is communicated to the various mobile devices using infrastructure (114).

The BubbleApps back-end server and client side applications can be developed using any known web application framework such as, Asp.net 2008 version 3.5 by Microsoft, in conjunction with application programming languages such as C#, graphic languages HTML and DHTML, and scripts such as JavaScript and Jquery. The present system and method can be built on any known architecture including for example a three layer architecture having a User Interface Layer, Business Logic Layer and Data Access Layer.

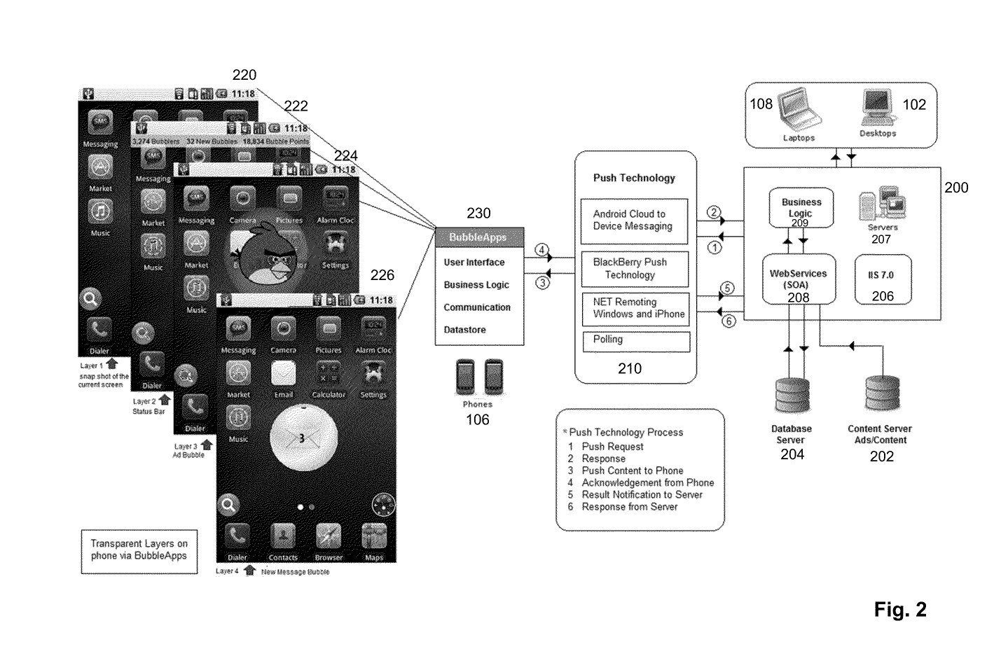

FIG. 2 illustrates the end to end system and the communication pathways between the BubbleApps servers (207, 202 and 204) and BubbleApps mobile client application on mobile phone (106) and BubbleApps web interface via computers (102). The end to end system of the present invention includes BubbleApps server (207) connected to a database server (204) and content server (202) for providing data to mobile devices such as phones (106) via polling or push technology (210). The BubbleApps server (207) operates to communicate with, and transmit content and other data to, mobile devices using business logic (209), web services (208) and request processing architecture (206).

The BubbleApps client app runs on the customer's smart phone mobile handset (106), mobile tablet or other computing device, as discussed above. BubbleApps client app (230) lets consumers choose their own unique content that gets delivered via a cloud based mobile tool that allows users to accept, and share coupons and content socially via the smart phone and web services through the mobile “MMAPI” communication gateways in real time. (The Mobile Media API (MMAPI) is an API specification for the Java ME platform CDC and CLDC devices such as mobile phones. Depending on how it is implemented, the APIs allow applications to play and record sounds and video, and to capture still images. MMAPI was developed under the Java Community Process as JSR 135.) The BubbleApps mobile client application (230) includes four main components: a user interface, business logic, communications and a data store.

The client app data store stores content received from the servers (202, 207) and other data, for display or storage on the user's mobile device. The data store can be accessed by the business logic and user interface to visualize the content.

The user interface is responsible for rendering the content generated from the platform/middle tier (112) to the phone. The user interface screens include settings screens, menus and advertisement content that has been directed to the user's mobile device.

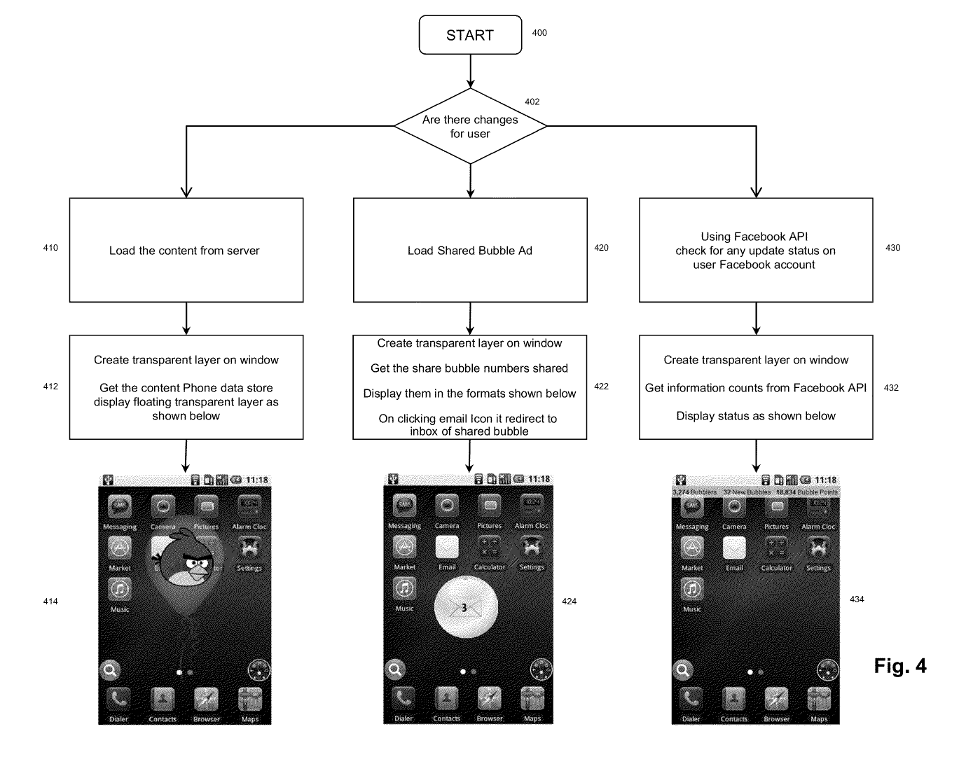

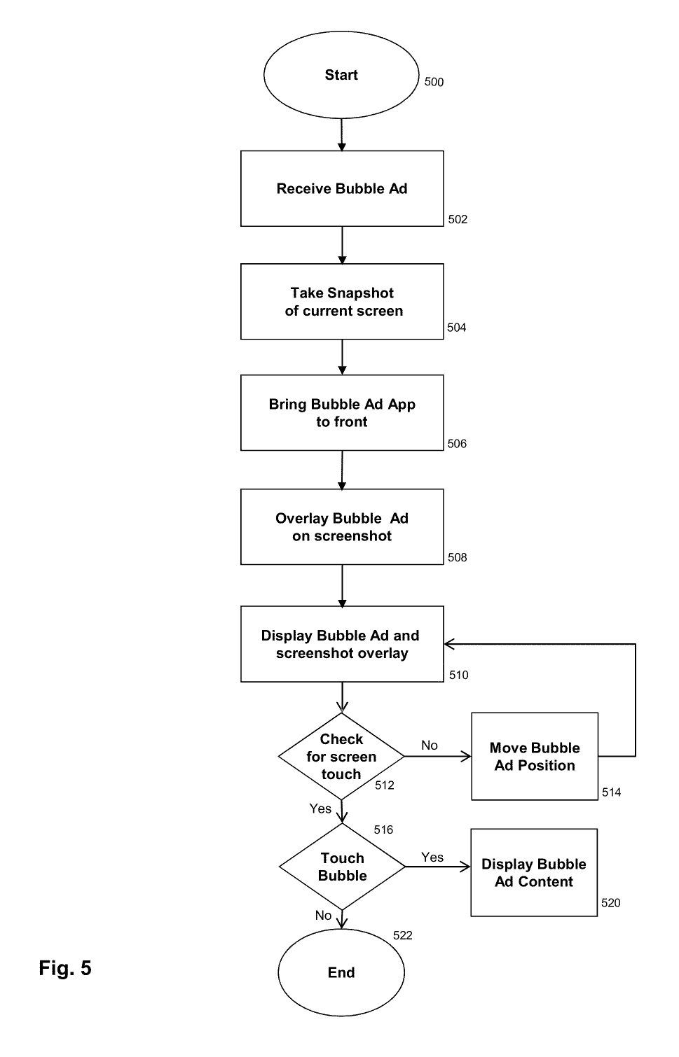

The client app business logic component creates the transparent layer on which advertisements are displayed, including by animating the advertisements, such as by moving and/or rotating the ads on the graphical display screen. The details of this process are discussed further below in conjunction with FIGS. 4 and 5. The business logic also functions to get or receive updated content from the BubbleApps server side (200, 202, 204) via either push technology (e.g., C2DM) or polling, as shown in 210. The business logic also serves to update the local data store with the received content and provide integration with the social networking facilities, such as the Facebook API. For example, when new content is available for a user on the server side, the user's mobile device uses the business logic to update its local data store with fresh ad content from the content server (202). The client app communications component works with the business logic to provide web services and polling.

The BubbleApps back-end server side components (200) include servers (207), business logic (209), web services (208) and request processing architecture (206) connected to database servers (204) and content servers (202).

The business logic (209), or domain logic, is a non-technical term generally used to describe the functional algorithms that handle information exchange between the databases and the user interface. In the present systems the server side business logic services include monitoring user content and distributing user content to users in a targeted manner based on user or advertiser criteria.

Web services (208) give the BubbleApps application web capabilities, so that it can publish its function or message to the rest of the world. The basic web services platform is XML+HTTP. Web services are self-contained and self-describing application components that communicate using open protocols and can be used by other applications. XML is the basis for web service and web services can be discovered using UDDI. Web Services have three basic platform elements: SOAP, WSDL and UDDI. In the present system, web service function to make the server side BubbleApps application components accessible to the BubbleApps client app on user mobile devices.

SOAP is an XML-based protocol to let applications exchange information over HTTP. SOAP stands for Simple Object Access Protocol. SOAP is a communication protocol and a format for sending messages. SOAP is designed to provide communications via the Internet that are platform and language independent. SOAP is a W3C standard that is designed to be simple and extensible and allows applications to get around firewalls. WSDL is an XML-based language for locating and describing web services. WSDL stands for Web Services Description Language and WSDL is based on XML. WSDL is a W3C standard. UDDI is a directory service where companies can register and search for Web services. UDDI is a directory for storing information about web services. UDDI communicates via SOAP. UDDI is built into the Microsoft .NET platform.

Internet Information Services 7.0 (IIS) (206) provides a request-processing architecture that includes: a new service, Windows Process Activation Service (WAS), which enables sites to use protocols other than HTTP and HTTPS, a Web server engine that can be customized by adding or removing modules, and a new approach to processing requests, and integrating the request-processing pipelines from IIS and ASP.NET. IIS 7 contains several components that perform important functions for the BubbleApps application and web server roles in Windows Server® 2008 (IIS 7.0) and Windows Server 2008 R2 (IIS 7.5). Each component has responsibilities, such as listening for requests made to the server from mobile devices or web users, managing processes, and reading configuration files. These components include protocol listeners, such as HTTP.sys, and services, such as World Wide Web Publishing Service (WWW service) and Windows Process Activation Service (WAS).

Protocol listeners receive protocol-specific requests, send them to IIS for processing, and then return responses to requestors. For example, when a client browser requests a Web page from the Internet, the HTTP listener, HTTP.sys, picks up the request and sends it to IIS for processing. Once IIS processes the request, HTTP.sys returns a response to the client browser. By default, IIS 7 provides HTTP.sys as the protocol listener that listens for HTTP and HTTPS requests. HTTP.sys was introduced in IIS 6.0 as an HTTP-specific protocol listener for HTTP requests. HTTP.sys remains the HTTP listener in IIS 7, but includes support for Secure Sockets Layer (SSL).

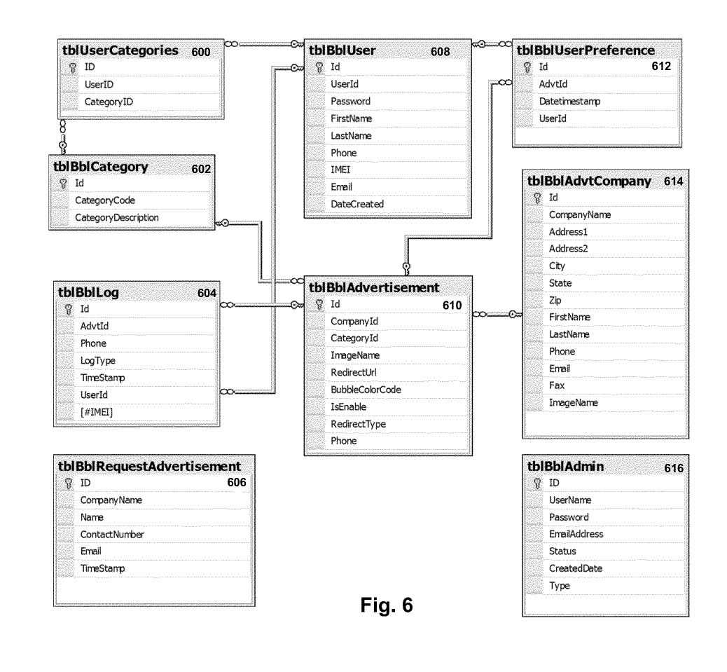

Also included are one or more database servers (202, 204) which store content associated with the BubbleApps app. These databases may be contained on one server or distributed across multiple servers or operated by third parties. For example, the ad/content server may be served by a third party ad server. FIG. 6 depicts an exemplary relational database illustrating user and ad content.

The ad/content database server 202 contains content and ads to be offered for download to users. Content Server (Ads/Content) (202) is the database instant responsible for providing ad creation, management and distribution. BubbleApps web services using XML SOAP connect to the database to distribute active advertisements to user mobile devices based on, for example, user preferences and geographical distribution selected by advertisers. Many other criteria can be used for directing the content to users based on the directed advertising model discussed below.

The database server 204 contains user information for users who have downloaded and installed the BubbleApps client app on their mobile device. The database server (204) is in the back-end system of a database application using client/server architecture. The back-end, sometimes called a database server, performs tasks such as data analysis, storage, data manipulation, archiving, and other non-user specific tasks. In the present system the database server functions to store user information, including registrations information, preference information and device specific information. Database management systems frequently provide database server functionality, and some DBMSs (e.g., MySQL) rely exclusively on the client-server model for database access. In the exemplary BubbleApps application, the MySQL Server 2008 server can be used.

Content is exchanged between the back-side servers and the mobile devices using the above described systems to either push content to mobile devices or to allow the mobile devices to periodically poll servers for new content.

Referring further to FIG. 2, the present system and method in a push embodiment of the system delivers content to user as follows. The content provider (202) sends a push request to the push technology infrastructure (step 1). The push technology infrastructure returns a response to the content provider, acknowledging receipt of the request, and queues the request for delivery (step 2). Then the infrastructure pushes the data to the specified devices, such as Android or Blackberry devices (step 3). Each phone device then returns a response to the push technology infrastructure, acknowledging receipt of the data (step 4). Finally, the push technology infrastructure forwards the acknowledgement on to the content push initiator (BubbleApps server) (step 5) and a read notification is returned to the push technology infrastructure (step 6). Depending on the type of content received, the data is updated and rendered in respective layers as shown in FIG. 2 (220, 222, 224, 226). In the case of receiving a shared bubble data, layer 4 receives confirmation of a new shared bubble and sender and receiver in and outboxes are updated accordingly (226). When the content received is a new set of ads content the BubbleApps application generates the floating content in transparent layer 3 (224).

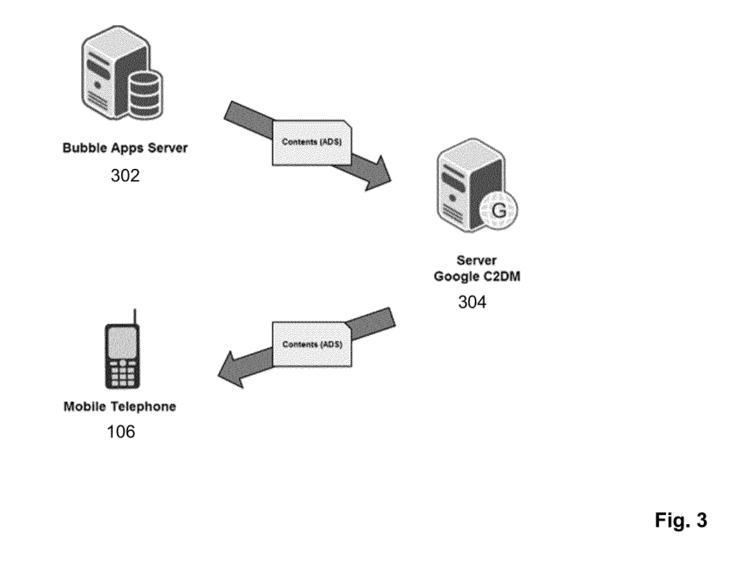

FIG. 3 illustrates the operation of the push system on mobile devices running the Android operating system. In these systems, Android Cloud to Device Messaging (C2DM) push technology is used to push content and advertisements to the BubbleApps client application in real time. Here, the Bubble Apps server sends push requests to the Goggle C2DMA Server for pushing the content, and then the C2DMA submits the request to mobile phone. Alternatively, on devices without push enable capabilities, polling may be used. Using polling, after specific intervals of time the phone will ping the server platform to see if there is any new content (e.g., advertisement or coupons) that is ready to be delivered to the mobile device.

### Content Delivery Flow (FIGS. 4 and 5)

The receipt and handling of content via polling or push technology is described with reference to FIGS. 4 and 5. An exemplary embodiment of the process flow in the BubbleApps app is presented herein with reference to FIG. 4. FIG. 4 illustrates the BubbleApps application's receipt, handling and display of new content, including receiving and displaying new ad content from the ad server, shared content from other BubbleApps users, and shared content through social networking sources such as Facebook and Twitter. FIG. 4 is a flow chart of the methodology that integrates these functions.

Referring to FIG. 4, the process starts at step 400. At step 402 the BubbleApps client app checks to determine if there is new content and, if so, whether the content is ad content, shared bubble ads or updates to social networking content such as Facebook. As discussed above, in some embodiments, the new content is pushed to the BubbleApps client app while in other embodiments the client app will periodically poll the content server for new content. Depending on what type of new content is available the BubbleApps app proceeds to either step 410 (ad content), 420 (shared bubble) or 430 (social network content).

If new ad content is available; at step 410 the BubbleApps client loads content from the server via the cloud. All content may be made available, or depending on user selected preferences, content may be targeted content based on user interests, current location data provided by the mobile device GPS, time, weather or the like. Following receipt of the content, the application proceeds to display the content in step 412 in a floating window as depicted in step 414. The method of simulating a floating window in mobile devices is detailed further in conjunction with FIG. 5.

If another user shares a bubble, at step 420 the BubbleApps app loads the shared bubbles from the content server. Once the shared bubbles are loaded, in step 422 a floating bubble displaying the number of shared bubbles is displayed overlaying the top layer screen of the mobile device. If the user touches or pops the bubble the BubbleApps app will be redirected to an inbox of shared bubbles for viewing.

If there is updated social networking content available, in step 430 the BubbleApps app checks and downloads the available content using for example the Facebook API and obtains information counts, such as how many bubbles the user has, how many bubbles are new and how many bubble points the user has. In some embodiments, bubble overlays are used in a methodology and apparatus to display graphics on the “top deck” of a mobile phone to “mirror” the latest activities inside of a user's social feed. If the user wants to “like” or “comment” or “share” or “retweet” or “direct message” or “respond” to any particular action within their social feed they will can use the messaging system of the present invention. BubbleApps application will maintain a log of the user activity and reward them via a credit which can be redeemed in the form of digital credit, real cash in the form of a gift card or donation to their favorite cause.

### Simulated Overlay Display Process (FIG. 5)

The APIs in current mobile device operating systems do not permit programmers to access or display an overlay on only a position of the screen. Rather, an application generally takes over the entire screen window when active. Accordingly, one aspect of the present invention is to simulate a floating overlay on the currently active screen. For example, without such simulation it would not be possible for a programmer to overlay a bubble on a mobile device home screen as depicted in steps 414 and 424 of FIG. 4. The display of floating content in an overlay on mobile devices is simulated in the present invention according to the exemplary process shown in FIG. 5.

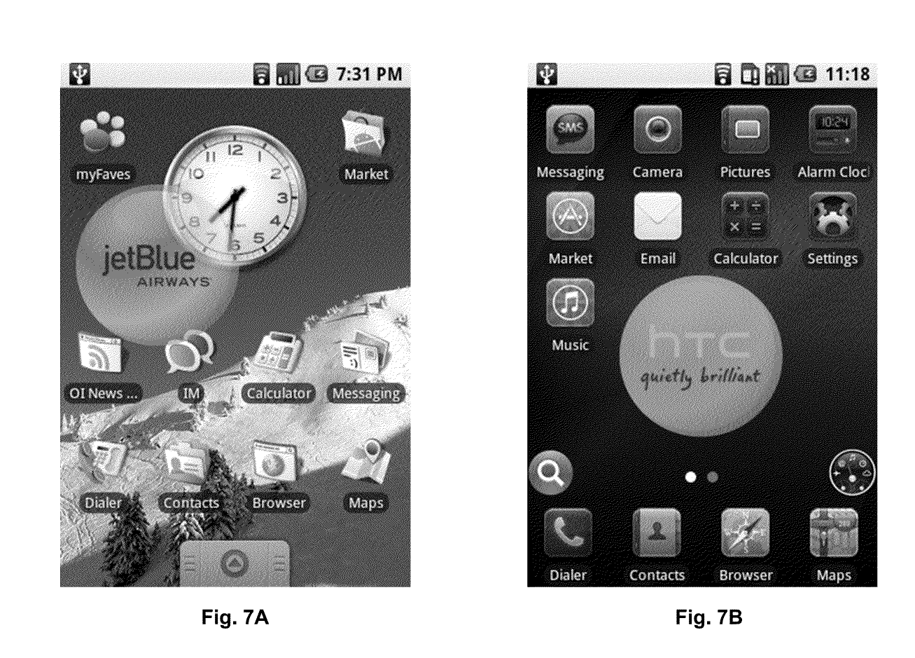

Referring to FIG. 5 the process starts at step 500. In step 502, the BubbleApps app receives or loads the content to be displayed as an overlay. In step 504 the BubbleApps app takes a screen shot of the currently active top layer screen. The currently active top layer screen is the one the user is currently viewing while the BubbleApps application is running in the background. In step 506, the BubbleApps application becomes the active top layer application. Following, in step 508, a composite image of the previously active top layer screen shot with the bubble app floating content image is generated. The content image is composited with the previous layer image so that the content image appears to be on top of the stored screen shot image (as shown in FIGS. 7A and 7B). The content image maybe an exact duplicate representation of the content received by the mobile device or its may be a modified image generated by the mobile device. For example, in some embodiments the mobile device may generate a representation of the content by generating a graphic from textual or other content received, or may scale or change the color of an image file received as content; in other, a representation of the content as used herein may also be an exact duplicate of the content received by the mobile device. Additionally, the content image and layer image can be composited with the content image being only partially opaque (as shown in FIG. 7A) so the screen shot image layer can be seen through the content image. The composited image is next displayed as the top level layer in step 510.

Using the process of the present invention, it appears to the mobile device user that the bubble ad content image is floating over whatever application had been active right before the bubble ad content image was received and displayed (FIGS. 7A and 7B). Using this technique provides a less intrusive user experience. Once the composite image is displayed on the screen, the BubbleApps application checks the queue or waits for an interrupt indicating a screen touch in step 512. If there is no screen touch interrupt the application can animate or move the bubble by repositioning the bubble relative to the underlying screen in step 514, and then cycle back to display the bubble in its new position at step 510. In this way the bubble ad can be moved around the mobile device screen to capture the user's attention.

If a screen touch interrupt is received, the process proceeds to step 516. In step 516 the screen touch is compared to the bubble content image overlay location to determine whether the user touched the bubble content or some other area of the screen. If the user touched the bubble content the BubbleApps may take any of a number of actions in step 520, including, for example, displaying the content, coupon or advertisement in fuller form, initiating a phone call to the advertiser, gifting the bubble or sharing the bubble via social networking apps such as Facebook or Twitter.

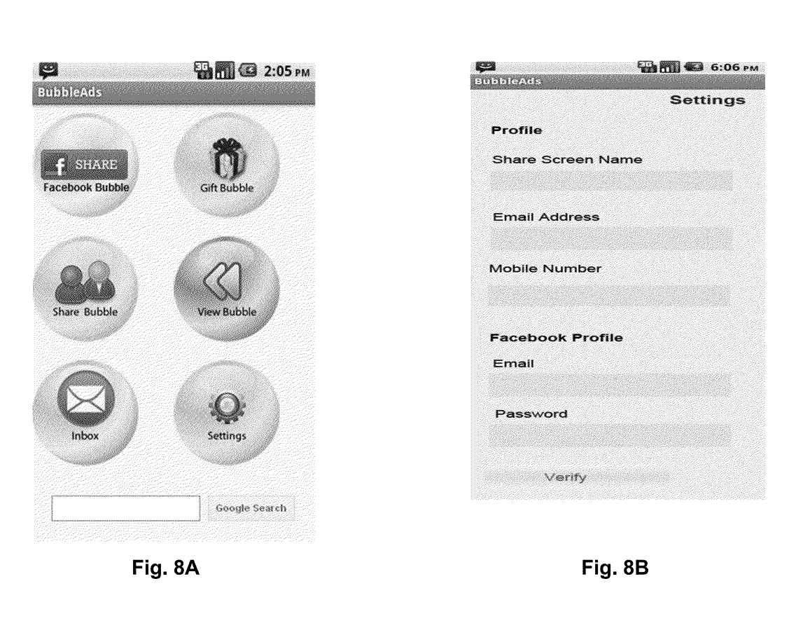

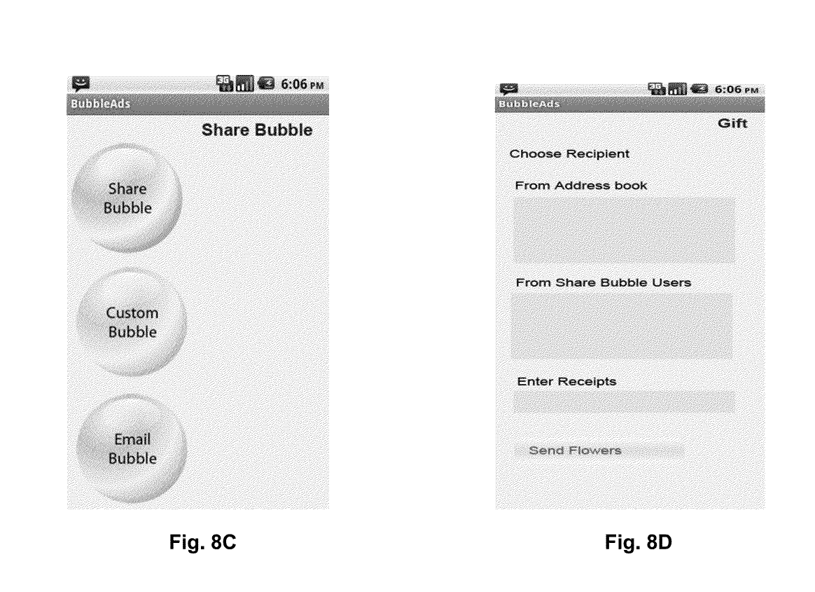

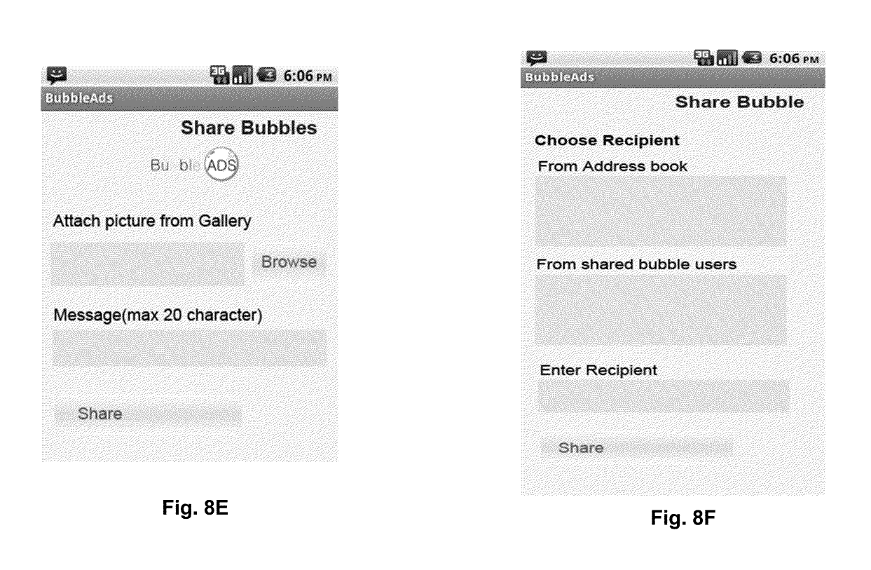

In certain embodiments, the application may be gesture sensitive so that the application has different responses to different gestures. For example, if the user taps the bubble the application may open a web browser app redirecting the user to the advertiser's website, or if the user long taps or touches the bubble with two fingers and opens the fingers up, the bubble ad will be zoomed, for example, by 50%. In other embodiments the long tap or zooming gesture may change the overlay bubble from an ad image to a menu image where the user can select from assorted options such as goto URL, call advertiser, discard, share, comment or the like. It will be further understood that in other embodiments of the invention the bubble can be configured to react to any number of gestures such as swiping or pinching. These or other possibilities are depicted in FIGS. 8A through 8F.

If a screen touch interrupt received in step 516 is outside of the bubble area, the BubbleApps closes and cedes its position as the active top layer app to the previous top layer app to further simulate the floating bubble user experience.

### Directed Advertisement

To further reduce the intrusiveness of the ads, some embodiments of the invention may employ methods for directed advertising. These methods may include targeting advertisement based on user selection, location, time, weather, or prior viewing history.

The proposed system and method may include preference settings whereby a user can select the types of advertisement or categories of advertisements that are of interest to a user. For example, a user may select coupons from various types of businesses such as restaurants, clothiers, supermarkets, etc. Another alternative is to present the user with a selection of interests, e.g., running, reading, travel, etc.

Similarly the proposed system and method can be configured to monitor a user's location and present coupons based on the user's location. For example, if the user is at a sporting event, the venue may deliver coupons for food or vendor purchases, or if the user is walking by a restaurant or department store a coupon or other advertisement can be delivered immediately to the user while they are in front of the store.

Yet other criteria for directing content may be the time of day or weather. For example, at lunch or dinner time in a particular region, targeted advertisement or coupons may be delivered to users for food or restaurants, or on sunny days coupons for sunscreen or umbrellas on rainy days.

Past viewing history may also be an indicator for future promotion delivery. For example, if the user has a history of viewing and using supermarket coupons and never using restaurant coupons, the user may be sent more supermarket coupons and fewer restaurant coupons.

The advertisements or content can be similarly tagged with keywords, content type descriptors or category descriptors that allow the system to match content with user preferences. In other embodiment the content or advertisements can also be time stamped to expire at a particular time or after being viewed for a period of time, or can be tied to geographic data and sent to the user based on the user's geographic location.

To further enhance the direction of advertisements, the system may combine multiple factors in determining whether to send a coupon. For example, if a user is passing a movie theater at 8 o'clock in the morning the system may not want to bother the user with a discount ticket or popcorn coupon. Control of the features can be variously regulated by either the user of the system or advertiser to not overwhelm the user.

Based on the user specific preferences and the content tagging the system and method can then deliver targeted content so that the user is not inundated with advertisement and promotions in which they have no interest. In some embodiments, the selection and deliver of content is made by the server so that each user only receives the content requested by the user. In other embodiments the server may deliver content to all users and allow the BubbleApps client software to filter and display only that content which satisfies the user preferences. In yet other embodiments the filtering and targeting functions may take place on both the client and server side. For example, the server may send a user only restaurant coupons based on the user preferences, but the client software may then display only those coupons that satisfy criteria associated with content tags, such as, only display a dinner coupon after 3 p.m. or only when the user is within a certain distance of the restaurant based on location data.

The entirety of this disclosure shows by way of illustration various embodiments in which the claimed invention may be practiced. In describing embodiments of the invention, in some cases specific terminology has been used for the sake of clarity; however, the invention is not intended to be limited to and/or by the specific terms so selected, and it is to be understood that each specific term includes all technical equivalents which operate in a similar manner to accomplish a similar purpose. It should be noted that terms and or phraseology in this disclosure are not exhaustive in detail, and are not provided as definitive definitions. Rather, the terms are provided herein simply as an aid to the reader. The terms are not limiting of the disclosure and/or claims herein. The use of the terms may contemplate any of the broader, and/or multiple meanings found in common use, dictionaries, technical dictionaries, and/or in actual use in the technical arts, as well as any broadening made throughout this disclosure.

Also, the advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, sequence, structural, temporal, and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of space and reducing repetition. For instance, it is to be understood that the logical and/or topological structure of any combination of any program components (a component collection), other components and/or any present feature sets as described in the figures and/or throughout are not limited to a fixed operating order and/or arrangement, but rather any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure.

What is claimed is:

1. A method for delivering content to a portable handheld mobile device, comprising:
storing content on a server, wherein the content is tagged with content specific tags;
storing user preference data on a server, wherein the user preference data includes a set of content specific preferences related to the type of content the user wants to receive;
selecting content to transmit to the mobile device of a user based on the mobile device user's content specific preferences and the content tags; and
transmitting the selected content to a mobile device's internet protocol address via a cloud based network for receipt and display on the user's mobile device in a floating overlay on a currently active screen layer of the user's mobile device.

2. The method of claim 1, wherein the content is at least one of promotional materials, coupons and advertisements.

3. The method of claim 1, wherein the content is at least one of an image or a video.

4. The method of claim 1, wherein transmitting comprises pushing the content to the user's mobile device.

5. The method of claim 1, wherein the content is transmitted to the user's mobile device in response to the user's mobile device polling the server.

6. The method of claim 1, wherein the content is stored on an advertisement server and the user data is stored on a data server.

7. The method of claim 1 further comprising receiving location data from a user's mobile device and selecting the content to transmit based on at least the location data.

8. The method of claim 1, wherein the content specific tags include at least one of content type, product type, location, expiration date, time and weather.

9. The method of claim 1, wherein the user preference data includes at least one of content type, product type, location, time, weather, and prior viewing history.

10. The method of claim 1, further comprising receiving a request to share content, and transmitting the content request to be shared to another user.

11. A mobile content delivery system for providing targeted content delivery to mobile devices, comprising:
a server connected to a network comprising:
at least one processor;
a database operatively connected to the processor for storing content tagged with content specific tags and for storing user preference data including a set of content specific preferences related to the type of content the user wants to receive;
a memory operatively connected to the processor, the memory storing program instructions that when executed by the processor, cause the processor to:
store content on the server;
store preference data associated with a plurality of mobile device users;
select content to send to a user's mobile device based on the mobile device user's content specific preferences and the content tags; and
transmit the selected content to a unique internet protocol address associate with the mobile device, for receipt and display on the user's mobile device in a floating overlay on a currently active screen layer of the user's mobile device.

12. The mobile content delivery system of claim 11, wherein the content is at least one of promotional materials, coupons and advertisements.

13. The mobile content delivery system of claim 11, wherein the content is at least one of an image or a video.

14. The mobile content delivery system of claim 11, wherein the instructions to transmit include instructions for pushing the content to the user's mobile device.

15. The mobile content delivery system of claim 11, wherein the instructions to transmit include instructions for transmitting to the user's mobile device in response to the user's mobile device polling the server.

16. The mobile content delivery system of claim 11, wherein the instructions further include instructions for (i) receiving location data from a user's mobile device and (ii) selecting the content to transmit based on at least the location data.

17. The mobile content delivery system of claim 11, wherein the content specific tags include at least one of content type, product type, location, expiration date, time and weather.

18. The mobile content delivery system of claim 11, wherein the user preference data includes at least one of content type, product type, location, time, weather, and prior viewing history.

19. The mobile content delivery system of claim 11, wherein the instructions further include instructions for (i) receiving a request to share content, and (ii) transmitting the content request to be shared to another user.

20. A portable handheld mobile device for receiving content via the cloud, comprising:
at least one processor;
at least one graphical display device operatively connected to the processor for displaying content;
at least one user input device operatively connected to the processor;
at least one memory operatively connected to the processor, the memory storing program instructions that when executed by the processor, cause the processor to:
receive content over a communications network via an internet protocol address associated with the mobile device;
store a screen shot image of a at least a portion of a currently active image on the graphical display device,
composite the a representation of the received content with the screen shot image, wherein the representation of the content defines a content image area sized smaller than the screen shot image, and
display the composited image on the graphical display device; and
determine whether a user has used the input device to select the content image area of the composite image displayed on the graphical display.

21. The portable handheld mobile device of claim 20, wherein the input device is a touch screen.

22. The portable handheld mobile device of claim 20, wherein the content is at least one of promotional materials, coupons and advertisements.

23. The portable handheld mobile device of claim 20, wherein the content is at least one of an image or a video.

24. The portable handheld mobile device of claim 20, wherein the memory further includes program instructions for causing the processor to receive content pushed to the user's mobile device.

25. The portable handheld mobile device of claim 20, wherein the memory further includes program instructions for causing the processor to (i) move the location of the representation of the received content with respect to the screen shot image, (ii) composite the representation of the received content with the screen shot image, (iii) display the composite image, and (iv) repeat the moving, compositing and displaying so that the content appears to move over the graphical display.

26. The portable handheld mobile device of claim 20, wherein the memory further includes program instructions for causing the processor to poll a content server for new content and receive new content from the sever.

27. The portable handheld mobile device of claim 20, wherein the memory further includes program instructions for causing the processor to transmit location data associated with the mobile device to a content server and wherein the received content from the content server is based on at least the location data.

28. The portable handheld mobile device of claim 20, the memory further stores a plurality of content and includes further program instructions for causing the processor to select content for display from among the plurality of content based on at least one of the location of the mobile device, time at the location of the mobile device, weather at the location of the mobile device, and past user content viewing history.

29. The portable handheld mobile device of claim 20, wherein the content specific tags include at least one of content type, product type, location, expiration date, time and weather.

30. The portable handheld mobile device of claim 20, wherein the user preference data includes at least one of content type, product type, location, time, weather, and prior viewing history.

31. The portable handheld mobile device of claim 20, wherein the memory further includes program instructions for causing the processor to display a menu if the user has selected the content image area.

32. The portable handheld mobile device of claim 20, wherein the memory further includes program instructions for causing the processor to offer to share the displayed content and transmit the content to another user if the user has selected the content image area.

33. A method for displaying content on a mobile device, the method comprising:
receiving content on the mobile device wherein the content is received over a communications network via an internet protocol address associated with the mobile device;
displaying a representation of the content to a user, wherein the displaying comprises:
storing a screen shot image of at least a portion of a currently active display screen;
compositing a representation of the content with the screen shot image, wherein the representation of the content is in a content image area sized smaller than the screen shot image;
displaying the composited image on a display screen of the mobile device;
determining whether a user has touched a touch sensitive screen of the mobile device; and
identifying whether the user has touched the content image area.

34. The method of displaying content of claim 33, further comprising selecting content to display on a graphical display of the mobile device based on a set of user preferences for type of content the user wants to receive.

35. The method of display content of claim 33, wherein the received content is content selected by a content server based on a set of user preferences for type of content the user wants to receive.

36. A computer readable medium storing thereon program instructions to be executed by a processor of a mobile device, the program instructions comprising:
(a) a first set of program instructions for causing the mobile device to receive content for display on the mobile device;
(b) a second set of program instructions for causing the mobile device to store a copy of at least a portion of a currently active screen display on the mobile device;
(c) a third set of program instructions for setting a screen display start position of the received content;
(d) a fourth set of program instructions for causing the mobile device to generate a composite image, the composite image being a composite of a representation of the received content overlaid on the stored copy of the active screen display;
(e) a fifth set of program instructions for causing the mobile device to display the composite image as the currently active screen display;
(f) a sixth set of program instructions for moving the position of the representation of the received content with respect to the stored copy of the active screen display; and
(g) a seventh set of program instructions for repeating steps (e) through (f) until an interrupt is received indicating that the user has touched the mobile device screen.
